(19) United States
(12) Patent Application Publication
(10) Pub. No.: US 2002/0087330 A1
(43) Pub. Date: Jul. 4, 2002

(54) Method of communicating a set of audio content

(75) Inventors: Jeffrey S. Lee, Phoenix, AZ (US); Richard L. Blanco, Tempe, AZ (US); Mathew Cucuzella, Tempe, AZ (US); Jack Scott Geranen, Phoenix, AZ (US); David Knappenberger, Tempe, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/753,907

(22) Filed: Jan. 3, 2001

(51) Int. Cl. G10L 19/00

(52) U.S. Cl. 704/500

(57) ABSTRACT

A method of communicating a set of audio content (300) from a communications node (104) to a remote communications node (200) includes assigning a set of content identifiers (115) to a set of audio content (300) via a user configuration device (116), wherein the user configuration device (116) is separate from a remote communications node (200) but coupled to communications node (104). The set of audio content (300) is requested utilizing the set of content identifiers (115) via remote communications node (200). The set of audio content (300) is converted from an encoded audio format (160, 162, 164) to a canonical audio format (166) at communications node (104). The requested set of audio content (300) in canonical audio format (166) is communicated from communications node (104) to remote communications node (200).

### FIELD OF THE INVENTION

This invention relates generally to content delivery and, in particular to a method of audio content delivery to a remote communications node.

### BACKGROUND OF THE INVENTION

A distributed communications system generally has a server component where content data is stored and a client component for requesting and utilizing content data. The client component can be an in-vehicle device or some other portable wireless device.

Prior art methods of delivering audio content to a remote client device in a distributed communications system require that the remote client device have powerful processors to implement sophisticated user interfaces, complex protocols and content rendering. The prior art remote client device needs to be able to process streaming content in a variety of formats, which requires expensive and relatively sophisticated processing capabilities. In addition, a large bandwidth is utilized to deliver the audio content to the remote client device, which limits the type and amount of audio content available to the user of the device. Current remote client devices that use voice recognition and buttons to navigate through audio content require navigating through a myriad of hierarchical menus in order to select desired content. This method of content selection is inconvenient and cumbersome when the remote client device is located in a vehicle, in addition to being potentially distracting to the user.

The prior art method of audio content delivery requires expensive, sophisticated processing in addition to providing limited selection due to bandwidth limitations. Coupled with a cumbersome method of selection, the prior art devices and methods of delivering audio content are costly and limit the audio content available to a user.

Accordingly, there is a significant need for method of delivering audio content that overcomes the deficiencies of the prior art outlined above.

### BRIEF DESCRIPTION OF THE DRAWINGS

Referring to the drawing:

FIG. 1 depicts an exemplary distributed communications system, according to one embodiment of the invention;

FIG. 2 depicts a remote communications node of an exemplary distributed communications system;

FIG. 3 depicts an exemplary set of audio content organized into a plurality of audio content nodes; and

FIG. 4 shows a flowchart depicting an exemplary method of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

The present invention is a method of communicating a set of audio content in a distributed communications system with software components running on mobile client platforms and on remote server platforms. To provide an example of one context in which the present invention may be used, an example of a method of communicating a set of audio content applied to a remote communications node will now be described. The present invention is not limited to implementation by any particular set of elements, and the description herein is merely representational of one embodiment. The specifics of one or more embodiments of the invention are provided below in sufficient detail to enable one of ordinary skill in the art to understand and practice the present invention.

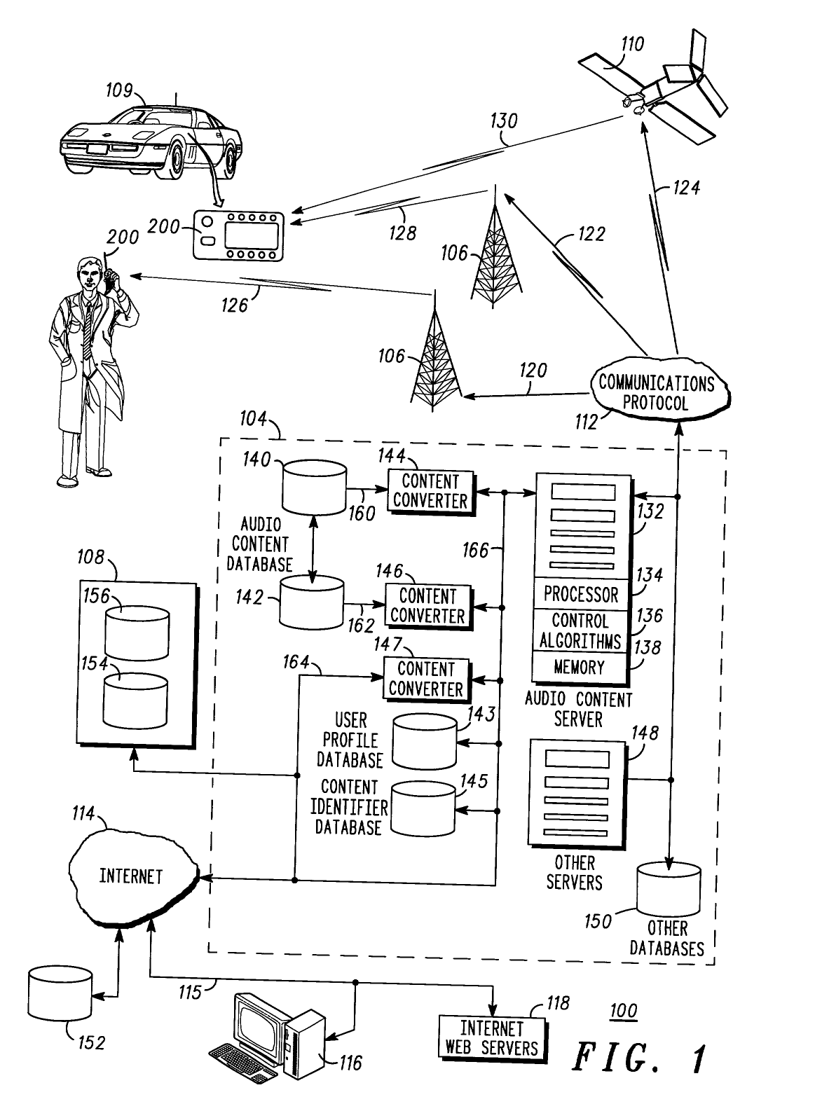

FIG. 1 depicts an exemplary distributed communications system 100 according to one embodiment of the invention. Shown in FIG. 1 are examples of components a distributed communications system 100, which comprises among other things, a communications node 104 coupled to a remote communications node 200. The communications node 104 and remote communications node 200 can be coupled via a communications protocol 112 that can include standard cellular network protocols such as GSM, TDMA, CDMA, and the like. Communications protocol 112 can optionally include standard TCP/IP communications equipment. The communications node 104 is designed to provide wireless access to remote communications node 200, to enhance regular audio broadcasts with extended audio content, and provide personalized broadcast, information and applications to the remote communications node 200.

Additionally, the distributed communications system 100 is capable of utilizing audio content in any number of formats and using any type of transport technology that can include, but is not limited to, USB (Universal Serial Bus); IEEE (Institute of Electrical and Electronics Engineers) Standards 1394-1995; and IEEE 802.11; and using protocols such as HTTP (hypertext transfer protocol); and UDP/IP (user datagram protocol/Internet protocol), and the like.

Communications node 104 can also serve as an Internet Service Provider to remote communications node 200 through various forms of wireless transmission. In the embodiment shown in FIG. 1, communications protocol 112 is coupled to local nodes 106 by either wireline link 120 or wireless link 122. Communications protocol 112 is also capable of communication with satellite 110 via wireless link 124. Content is further communicated to remote communications node 200 from local nodes 106 via wireless link 126, 128 or from satellite 110 via wireless link 130. Wireless communication can take place using a cellular network, FM sub-carriers, satellite networks, and the like. The components of distributed communications system 100 shown in FIG. 1 are not limiting, and other configurations and components that form distributed communications system 100 are within the scope of the invention.

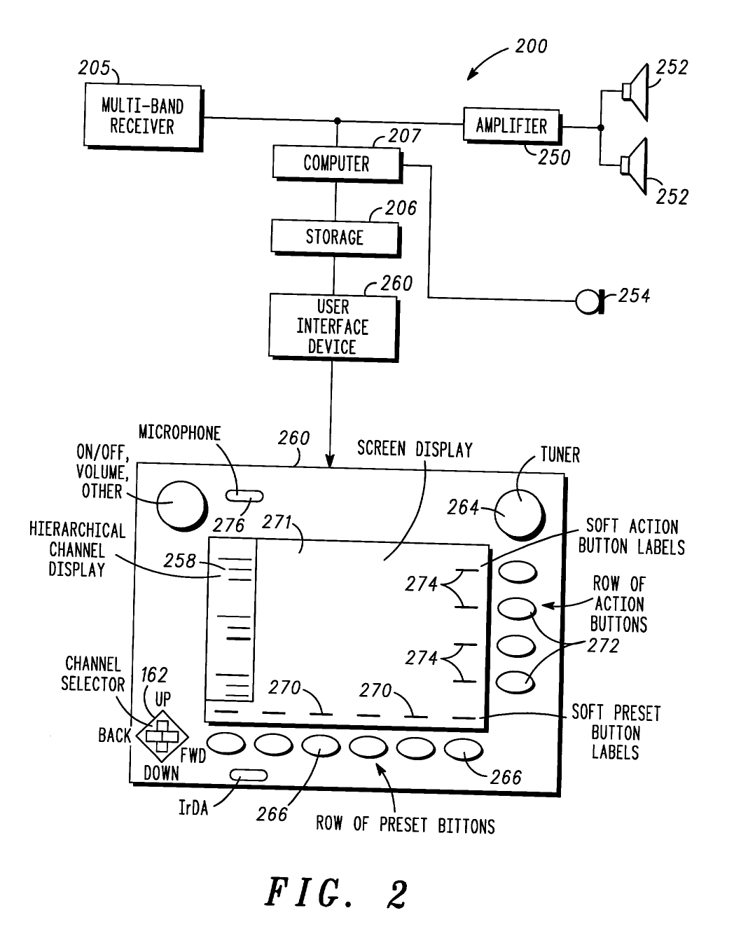

Remote communications node 200 without limitation can include a wireless unit such as a cellular or Personal Communication Service (PCS) telephone, a pager, a hand-held computing device such as a personal digital assistant (PDA) or Web appliance, or any other type of communications and/or computing device. Without limitation, one or more remote communications nodes 200 can be contained within, and optionally form an integral part of a vehicle, such as a car 109, truck, bus, train, aircraft, or boat, or any type of structure, such as a house, office, school, commercial establishment, and the like. As indicated above, a remote communications node 200 can also be implemented in a device that can be carried by the user of the distributed communications system 100. An exemplary remote communications node 200 will be discussed below with reference to FIG. 2.

Communications node 104 can also be coupled to other communications nodes 108, the Internet 114 and other Internet web servers 118. Users of distributed communications system 100 can create user-profiles and configure/personalize their user-profile through a user configuration device 116, such as a computer. Other user configuration devices are within the scope of the invention and can include a telephone, pager, PDA, Web appliance, and the like. User-profiles and other configuration data is preferably sent to communications node 104 through a user configuration device 116, such as a computer with an Internet connection 114 using a web browser as shown in FIG. 1. Due to the large number of possible analog, digital and Internet based broadcasts available for reception by communications node 104, choosing from the huge variety of broadcasts is less complicated if it is preprogrammed or pre-configured in advance by the user through user configuration device 116 rather than from remote communications node 200 itself. The user would log onto the Internet 114 in a manner generally known in the art and then access the configuration web page of the communications node 104. Once the user has configured the web page selections as desired, he/she can submit the changes. The new configuration, including an updated user-profile, can then be transmitted to the remote communications node 200 from communications node 104.

User configuration device 116 can be used to assign a set of content identifiers 115 to a set of audio content by logging onto the configuration web page as described above. Set of content identifiers can be an integral part of a user-profile, where the set of content identifiers are user-assigned to the set of audio content. Set of content identifiers 115 can comprise a code, macro, lexical element, frequency, and the like that is associated with a specific set of audio content. For example, interface elements (i.e. virtual software buttons, hard buttons, and the like) of a user interface device (shown in FIG. 2) of a remote communications node 200 can be assigned to a set of audio content as a set of content identifiers 115. As another example, lexical elements, such as voice recognition (VR) commands or phrases can be assigned to a set of audio content as a set of content identifiers 115. As yet another example, signals such as dual tone multi-frequency (DTMF) signals can be assigned to a set of audio content as a set of content identifiers 115. Another example can include assigning an address, DTMF signal, and the like, to lexical elements, interface elements, and the like, so that when an interface element is depressed, a signal or code is sent to request the associated set of audio content. The set of content identifiers 115 can be stored in content identifier database 145 at communications node 104. The aforementioned set of content identifiers are some of many possible sets of content identifiers. As those skilled in the art will appreciate, the set of content identifiers mentioned above are meant to be representative and to not reflect all possible sets of content identifiers that may be employed.

As shown in FIG. 1, communications node 104 comprises audio content server 132 coupled to any number of audio content databases 140, 142, to user-profile database 143 and to content identifier database 145. Communications node 104 also comprises other servers 148, for example central gateway servers, wireless session servers, navigation servers, and the like. Other databases 150 are also included in communications node 104, for example, customer databases, broadcaster databases, advertiser databases, and the like.

Audio content server 132 comprises a processor 134 with associated memory 138. Memory 138 comprises control algorithms 136, and can include, but is not limited to, random access memory (RAM), read only memory (ROM), flash memory, and other memory such as a hard disk, floppy disk, and/or other appropriate type of memory. Communications node 104 and audio content server 132 can initiate and perform communications with other remote communication nodes 200, user configuration devices 116, and the like, shown in FIG. 1 in accordance with suitable computer programs, such as control algorithms 136, stored in memory 138.

Audio content server 132, while illustrated as coupled to communications node 104, could be implemented at any hierarchical level(s) within distributed communications system 100. For example, audio content server 132 could also be implemented within other communication nodes 108, local nodes 106, the Internet 114, and the like.

Audio content databases 140, 142 contain any numbers of sets of audio content. Sets of audio content can be in any number of encoded audio formats including, but not limited to ADPCM (adaptive differential pulse-code modulation); CD-DA (compact disc—digital audio) digital audio specification; and ITU (International Telecommunications Union) Standards G.711, G.722, G.723 & G.728, MP3, AC-3, AIFF, AIFC, AU, Pure Voice, Real Audio, WAV, and the like. Set of audio content can be recorded audio content, streaming audio content, broadcast audio content, and the like.

Communications node 104 is coupled to and has access to external audio content sources 152, 154, 156, which can be located in other communications nodes 108, satellites 110, on other databases via the Internet 114, and the like. These are considered external audio content sources 152, 154, 156 because they are external to communications node 104 although they can be encompassed by a distributed communications system 100.

Communications node 104 also comprises content converters 144, 146, 147 for each encoded audio format. Content converters 144, 146, 147 can be software modules, hardware, and the like, that convert a set of audio content from its respective encoded audio format 160, 162, 164 into a canonical audio format 166 prior to communicating the set of audio content to remote communications node 200. Canonical audio format 166 can be any format or encoding method that allows a set of audio content to be communicated to remote communications node 200 from communications node 104, for example digital audio, analog audio, and the like. In this manner, encoded audio formats 160, 162, 164 are all converted to a common audio format for communication to remote communications node 200. As depicted in FIG. 1, a content converter 144, 146 is dedicated to an audio content database 140, 142 that contains a set of audio content in a particular format. For example, if audio content database 140 contained a set of audio content in a WAV format, content converter can be a software module, or player, that converts the set of audio content in WAV format to a canonical audio format 166. As another example, a set of audio content from an external audio content source 152, 154, 156 can have a content converter 147 dedicated to conversion to canonical audio format 166. The configuration depicted in FIG. 1 is in no way limiting. Other configurations of audio content server 132, convent converter 144, 146, 147, audio content database 140, 142 and external audio content source 152, 154, 156 are within the scope of the invention.

FIG. 2 depicts an exemplary remote communications node 200 of an exemplary distributed communications system 100. The remote communications node 200 depicted in FIG. 2 is not limiting and can include any of the devices listed with reference to FIG. 1. As shown in FIG. 2, remote communications node 200 consists of a computer, preferably having a microprocessor and memory 207, and storage devices 206 that contain and run an operating system and applications to control and communicate with onboard receivers, for example a multi-band AM, FM, audio and digital audio broadcast receiver 205, and the like. Sound is output through an industry standard amplifier 250 and speakers 252. A microphone 254 allows for voice recognition commands to be given and received by remote communications node 200.

The remote communications node 200 can optionally contain and control one or more digital storage devices 206 to which real-time broadcasts can be digitally recorded. The storage devices 206 may be hard drives, flash disks, or other automotive grade storage media. The same storage devices 206 can also preferably store digital data that is wirelessly transferred to remote communications node 200 in faster than real time mode. Examples of such digital materials are MP3 audio files or nationally syndicated radio shows that can be downloaded from communications node 104 and played back when desired rather than when originally broadcast.

As FIG. 2 shows, remote communications node 200 can use a user interface device 260 having a plurality of interface elements to present information to the user and to control the remote communications node 200. The invention is not limited by the user interface device 260 or the interface elements depicted in FIG. 2. As those skilled in the art will appreciate, the user interface device 260 and interface elements shown in FIG. 2 are meant to be representative and to not reflect all possible user interface devices or interface elements that may be employed. Interface elements (such as hard and soft buttons, knobs, microphone, switches, and the like) type and location shown in FIG. 2 are one possible embodiment for interface elements. Those skilled in the art will appreciate that interface elements type and locations may vary in different implementations of the invention. In one presently preferred embodiment, for example, the display screen 271 includes a 5½ inch 640×480, 216 color VGA LCD display. In an alternate embodiment, the display screen 271 can display as little as two lines of text, whereas an upper limit of display screen 271 can be as large as the intended application may dictate.

The channel selector 262, tuner 264 and preset button 266 interface elements shown in FIG. 2 allow the user to broadly navigate all the channels of audio broadcasts and information services available on remote communications node 200. The channel selector 262 allows a user to manually access and select any of the audio and information channels available by browsing through them (up, down, forward, back) in a hierarchical tree. A portion of the hierarchical tree 258 is shown on the display screen 271. The root of the tree preferably contains major categories of channels. Possible types of major channel categories could include music, talk, TV audio, recorded audio, personalized directory services and information services. As is explained in detail below, the user can configure the presentation of major categories and subcategories so that he/she sees only those categories of interest.

Preset buttons 266 on the display screen 271 are user configurable buttons that allow the user to select any one channel, group of channels or even channels from different categories that can be played or displayed with the press of a single button. For example, a user could configure a preset button 266 to simply play a favorite country station when pressed. The user could also configure a preset button 266 to display all the country stations in a specific area. The user could even configure a preset button 266 to display their favorite blues, country and rock stations at one time on one display screen 271. Once these groups of channels are displayed, the user can play the radio stations by using the channel selector buttons 262. A preset button 266 can also be assigned to any personal information channel application. For example, assigning a new channel (application) that shows all hospitals in an area would result in a map showing the nearest hospitals to the vehicle's current position when the preset is pushed. User defined labels 270 for preset buttons 266 preferably appear on the display screen 271 above the preset buttons 266 to indicate their purpose.

The tuner control 264 shown in FIG. 2 flattens the hierarchical tree 258. Rather than having to step through categories and subcategories to play a channel, by turning the tuner control 264 the user can play each channel one after the other in the order they appear in the hierarchy 258. If a user has configured the device to show only a few categories of channels, this allows fast sequencing through a channel list. Pressing the tuner control 264 preferably causes the remote communications node 200 to scan through the channels as a traditional radio would do, playing a few seconds of each station before moving to the next in the hierarchy 258.

Computer programs running in remote communications node 200 control the action buttons 272 shown in FIG. 2. Action buttons labels 274 and purposes may change from program to program. A button's label 274 indicates its current function. Some examples of action buttons 272 could be: “INFO” to save extended information on something that is being broadcast (e.g., the Internet web address of a band currently playing); “CALL” to call a phone number from an advertisement; “NAV” to navigate to an address from an electronic address book; or “BUY” to purchase an item currently being advertised.

A microphone input 276 allows users to control remote communications node 200 verbally rather than through the control buttons. Key word recognition software allows the user to make the same channel selections that could be made from any of the button controls. Audio feedback through speech synthesis allows the user to make selections and hear if any other actions are required. Software or hardware based voice recognition and speech synthesis may be used to implement this feature.

In FIGS. 1-2, audio content server 132 of communications node 104 and computer 207 of remote communications node 200, perform distributed, yet coordinated, control functions within distributed communications system 100 (FIG. 1). Audio content server 132 and computer 207 are merely representative, and distributed communications system 100 can comprise many more of these elements within other communications nodes 108 and remote communications nodes 200.

Audio content server 132 and computer 207 of remote communications node 200 comprise portions of data processing systems that perform processing operations on computer programs that are stored in computer memory. Audio content server 132 and computer 207 also read data from and store data to memory, and they generate and receive control signals to and from other elements within distributed communications system 100.

Software blocks that perform embodiments of the invention are part of computer program modules comprising computer instructions, such as control algorithms 136 (FIG. 1), that are stored in a computer-readable medium such as memory 138. Computer instructions can instruct audio content server 132 and computer 207 to perform methods of operating communications node 104 and remote communications node 200. In other embodiments, additional modules could be provided as needed, and/or unneeded modules could be deleted.

The particular elements of the distributed communications system 100, including the elements of the data processing systems, are not limited to those shown and described, and they can take any form that will implement the functions of the invention herein described.

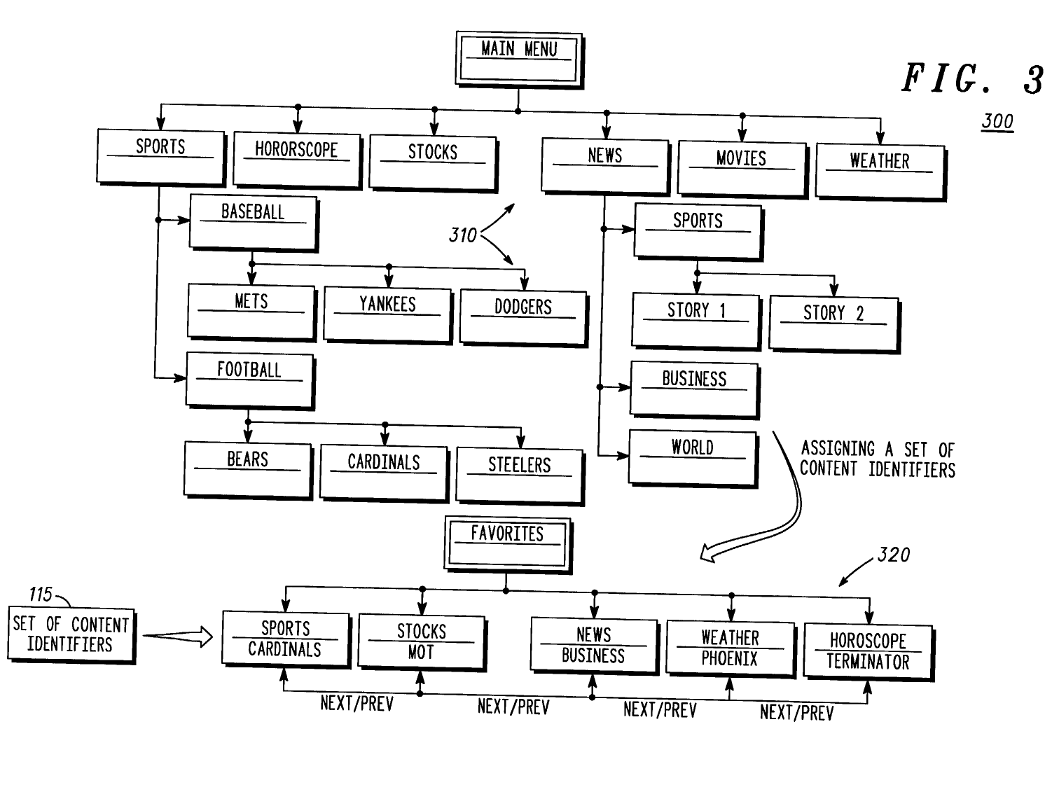

FIG. 3 depicts an exemplary set of audio content 300 organized into a plurality of audio content nodes 310. As shown in FIG. 3, set of audio content 300 in a distributed communications system 100 is traditionally organized into a plurality of audio content nodes 310 arranged in a hierarchy. In order to access audio content, a hierarchical menu must be navigated down to the set of audio content desired. This can be done using interface elements described above, voice recognition, and the like. By assigning a set of content identifiers 115 to at least one of a the plurality of audio content nodes, or by assigning a set of content identifiers 115 to one or more of the plurality of audio content nodes 310, a flattened menu hierarchy 320 of plurality of audio content nodes is realized. For example, a set of content identifiers 115 can be assigned to Sports/Cardinals as shown in FIG. 3. The set of content identifiers 115 can include DTMF signals, mapping to interface elements, mapping to lexical elements via voice recognition, and the like. Only one set of content identifiers 115 is shown in FIG. 3, however each of the plurality of audio content nodes 310 in the flattened menu hierarchy 320 can have a set of content identifiers 115 associated with it. In addition, navigation functions such as “NEXT” and “PREVIOUS” can have a set of content identifiers assigned as well.

The flattened menu hierarchy can be navigated by traditional step through or scan methods outlined above or by assigning a set of content identifiers 115 to additional interface elements, lexical elements, signals, and the like. For example, a set of content identifiers can be assigned to voice recognition lexical elements such as “NEXT” and “PREVIOUS” in order to navigate the flattened menu 320. As another example, interface elements on user interface device 260 can be assigned via a set of content identifiers to be navigation buttons for “NEXT” and “PREVIOUS.”

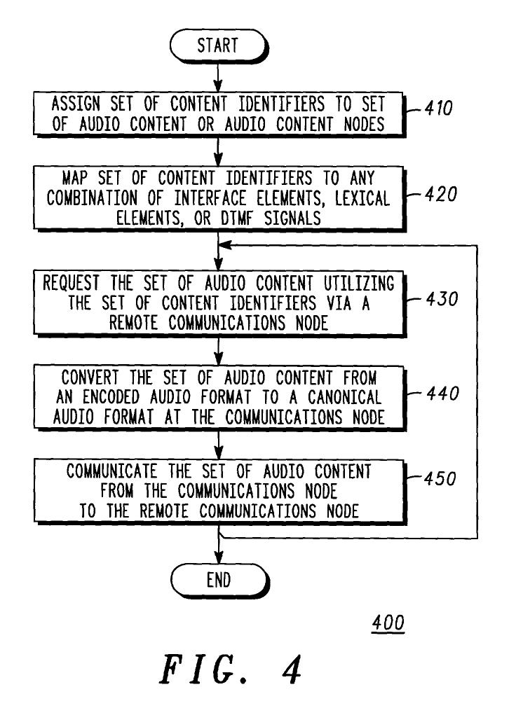

FIG. 4 shows a flowchart 400 depicting an exemplary method of the invention depicting a method of communicating a set of audio content 300 from a communications node 104 and of selecting a set of audio content 300 from a plurality of audio content nodes 310 via a communications node 104. In step 410, a set of content identifiers 115 are assigned to a set of audio content 300 or a plurality of audio content nodes 310 via a user configuration device 116. Preferably, the user configuration device 116 is separate from remote communications node 200 and coupled to communications node 104.

In step 420, set of content identifiers 115 is mapped to any combination of a one or more plurality of interface elements, one or more lexical elements, signals such as one or more DTMF signals, and the like. Set of content identifiers 115 can be assigned by a user, stored in content identifier database 145 at communications node 104 and mapped either automatically or to user specified elements above. Set of content identifiers 115 is then downloaded to remote communications node 200, for example as part of a user-profile, to enable selection of a set of audio content 300 from remote communications node 200.

In step 430, set of audio content 300 is requested utilizing set of content identifiers 115 via remote communications node 200. For example, if set of content identifiers consists of signals mapped to interface elements on user interface device 260, set of audio content 300 can be requested utilizing the interface elements, and thereby dispense with navigating through hierarchical menus in order to arrive at the set of audio content 300 or any of the plurality of audio content nodes 310 desired. In another example, set of content identifiers 115 could be lexical elements implemented utilizing voice recognition so any desired plurality of audio content nodes 310 can be reached by utilizing VR software and the lexical element that was previously assigned to the set of audio content 300 or any of the plurality of audio content nodes 310. In still another example, set of content identifiers can be digital or analog signals, such as DTMF signals, whereby set of audio content 300 is requested by sending such signals utilizing remote communications node 200. The requested set of audio content 300 can be requested from a database, such as an audio content database 140, 142 at communications node 104. Set of audio content 300 can also be requested from an external audio content source 152, 154, 156 from other communications nodes 108 or from an external audio content source 152 available through the Internet 114. Exactly where set of audio content 300 is physically located may not be apparent to the requesting entity.

In step 440, set of audio content 300 is converted from an encoded audio format 160, 162, 164 to a canonical audio format 166 at communications node 104. Converting to a canonical audio format 166 at communications node 104 allows the processing of different encoding formats to take place outside of remote communications node 200, thereby reducing the processing power, software, cost and complexity of remote communications node 200. Once set of audio content 300 is converted to a canonical audio format 166, communications node 104 can then easily communicate one such canonical, or standard, format to remote communications node 200. For example, set of audio content 300 in canonical audio format 166 can be communicated in digital or analog audio over a cellular network to remote communications node 200. This example is in no way limiting of the invention. As those skilled in the art will appreciate, many canonical audio formats 166 are available to communicate set of audio content 300 to remote communications node 200, and the previous example is meant to be representative and does not reflect the only possible format or method of communicating set of audio content 300 in canonical audio format 166 to remote communications node 200.

In step 450, set of audio content 300 requested by remote communications node 200 is communicated from communications node 104 to remote communications node 200. Additional sets of audio content 300 can then be requested, converted and communicated to remote communications node 200 as indicated by the return loop arrow in FIG. 4.

While we have shown and described specific embodiments of the present invention, further modifications and improvements will occur to those skilled in the art. We desire it to be understood, therefore, that this invention is not limited to the particular forms shown and we intend in the appended claims to cover all modifications that do not depart from the spirit and scope of this invention.

1. In a remote communications node, a method of communicating a set of audio content from a communications node comprising:
assigning a set of content identifiers to the set of audio content via a user configuration device, wherein the user configuration device is separate from the remote communications node, and wherein the user configuration device is coupled to the communications node;
requesting the set of audio content utilizing the set of content identifiers via the remote communications node;
converting the set of audio content from an encoded audio format to a canonical audio format, wherein converting the set of audio content occurs at the communications node; and
communicating the set of audio content from the communications node to the remote communications node.

2. The method of claim 1, further comprising providing on the remote communications node a user interface device having a plurality of interface elements and mapping the set of content identifiers to one or more of the plurality of interface elements.

3. The method of claim 1, further comprising mapping the set of content identifiers to one or more lexical elements.

4. The method of claim 1, further comprising mapping the set of content identifiers to one or more dual tone multi-frequency signals.

5. The method of claim 1, wherein requesting the set of audio content comprises requesting the set of audio content from a database, wherein the database is coupled to the communications node.

6. The method of claim 1, wherein requesting the set of audio content comprises requesting the set of audio content form an external audio content source, wherein the external audio content source is coupled to the communications node.

7. The method of claim 1, further comprising providing a user-profile, wherein the user-profile comprises the set of content identifiers, and wherein the set of content identifiers are user-assigned to the set of audio content.

8. The method of claim 1, wherein the set of audio content comprises a plurality of audio content nodes, and wherein the plurality of audio content nodes are arranged in a hierarchy.

9. The method of claim 8, further comprising assigning the set of content identifiers to at least one of the plurality of audio content nodes.

10. The method of claim 1, wherein requesting the set of audio content comprises requesting the set of audio content utilizing the remote communications node.

11. In a remote communications node, a method of selecting a set of audio content from a plurality of audio content nodes via a communications node comprising:
assigning a set of content identifiers to one or more of the plurality of audio content nodes, wherein the set of content identifiers is assigned to one or more of the plurality of audio content nodes via a user configuration device, wherein the user configuration device is separate from the remote communications node;
requesting the set of audio content via the remote communications node by selecting one or more of the plurality of audio content nodes utilizing the set of content identifiers;
converting the set of audio content from an encoded audio format to a canonical audio format, wherein converting the set of audio content occurs at the communications node; and
communicating the set of audio content to the remote communications node.

12. The method of claim 11, further comprising providing on the remote communications node a user interface device having a plurality of interface elements and mapping the set of content identifiers to one or more of the plurality of interface elements.

13. The method of claim 11, further comprising mapping the set of content identifiers to one or more lexical elements.

14. The method of claim 11, further comprising mapping the set of content identifiers to one or more dual tone multi-frequency signals.

15. The method of claim 11, wherein requesting the set of audio content comprises requesting the set of audio content from a database, wherein the database is coupled to the communications node.

16. The method of claim 11, wherein requesting the set of audio content comprises requesting the set of audio content form an external audio content source, wherein the external audio content source is coupled to the communications node.

17. The method of claim 11, further comprising providing a user-profile, wherein the user-profile comprises the set of content identifiers, and wherein the set of content identifiers are user-assigned to one or more of the plurality of audio content nodes.

18. The method of claim 11, wherein requesting the set of audio content comprises requesting the set of audio content utilizing the remote communications node.

19. A computer-readable medium containing computer instructions for instructing a processor to perform a method of communicating a set of audio content from a communications node, the instructions comprising:
assigning a set of content identifiers to a set of audio content via a user configuration device, wherein the user configuration device is separate from the remote communications node, and wherein the user configuration device is coupled to the communications node;
requesting the set of audio content via a remote communications node utilizing the set of content identifiers;
converting the set of audio content from an encoded audio format to a canonical audio format, wherein converting the set of audio content occurs at the communications node; and
communicating the set of audio content to a remote communications node.

20. The computer-readable medium in claim 19, the instructions further comprising mapping the set of content identifiers to one or more of a plurality of interface elements, wherein the plurality of interface elements are on the remote communications node.

21. The computer-readable medium in claim 19, the instructions further comprising mapping the set of content identifiers to one or more lexical elements.

22. The computer-readable medium in claim 19, the instructions further comprising mapping the set of content identifiers to one or more dual tone multi-frequency signals.

23. The computer-readable medium in claim 19, the instructions further comprising assigning the set of content identifiers to at least one of a plurality of audio content nodes.
